(19) United States
(12) Patent Application Publication
(10) Pub. No.: US 2015/0262244 A1
(43) Pub. Date: Sep. 17, 2015

(54) CUSTOMIZABLE USER PREFERENCE INFORMATION FOR USER DEVICES

(71) Applicants: CELLCO PARTNERSHIP D/B/A VERIZON WIRELESS, BASKING RIDGE, NJ (US); VERIZON PATENT AND LICENSING INC., BASKING RIDGE, NJ (US)

(72) Inventors: STEVEN R. RADOS, DANVILLE, CA (US); DONNA L. POLEHN, KIRKLAND, WA (US); ARDA AKSU, MARTINEZ, CA (US); LALIT R. KOTECHA, SAN RAMON, CA (US); KENT W. HUGHES, OAKLAND, CA (US); MINGXING LI, SAN JOSE, CA (US)

(73) Assignees: CELLCO PARTNERSHIP D/B/A VERIZON WIRELESS, BASKING RIDGE, NJ (US); VERIZON PATENT AND LICENSING INC., BASKING RIDGE, NJ (US)

(21) Appl. No.: 14/204,430

(22) Filed: Mar. 11, 2014

(51) Int. Cl. G06Q 30/02

(52) U.S. Cl. CPC G06Q 30/0269

(57) ABSTRACT

A user device receives, from a device associated with a vendor, a request for user preferences associated with a user of the user device. The user preferences are stored in a memory associated with the user device. The user device authenticates the vendor, and determines particular user preferences, from the user preferences, that are relevant to the vendor. The device approves the request for the user preferences when the vendor is authenticated. The device retrieves the particular user preferences from the memory based on the approval of the request for the user preferences, and provides the particular user preferences to the device. The particular user preferences are used to determine products, services, or content, of the vendor, to offer to the user.

### BACKGROUND

Users today utilize a variety of mobile devices, such as cell phones, smart phones, tablet computers, etc., to access online services (e.g., email applications, Internet services, television services, etc.), purchase products, services, and/or content, and/or perform other tasks. Information associated with the users (e.g., personal preferences, personal information, credit card numbers, etc.) may be shared with vendors (e.g., businesses, organizations, etc.) that provide such products, services, and/or content so that the users can access and interact with the vendors in an efficient manner.

### BRIEF DESCRIPTION OF THE DRAWINGS

FIG. 1 is a diagram of an overview of an example implementation described herein;

FIG. 2 is a diagram of an example environment in which systems and/or methods described herein may be implemented;

FIG. 3 is a diagram of example components of one or more devices of FIG. 2;

FIG. 4 is a flow chart of an example process for receiving and configuring a favorites application for a user device;

FIGS. 5A and 5B are diagrams of an example user interface that may be used in connection with the example process shown in FIG. 4;

FIG. 6 is a diagram of an example data structure that stores private preferences, public preferences, and trusted vendor information associated with a user of a user device;

FIG. 7 is a flow chart of an example process for securely providing user preferences to a vendor server; and

FIGS. 8A-8E are diagrams of an example relating to the example process shown in FIG. 7.

### DETAILED DESCRIPTION OF PREFERRED EMBODIMENTS

The following detailed description refers to the accompanying drawings. The same reference numbers in different drawings may identify the same or similar elements.

Many users do not permit information associated with the users to be shared with vendors even when the vendors may provide valuable products, services, and/or content to the users. One reason that users do not share their information is the fear that the information may be used for improper purposes, such as credit card theft, identity theft, fraud purposes, etc. Vendors are constantly trying to find out as much about users as possible so that the vendors can market appropriate products, services, and/or content to the users. However, most vendors know very little about the users of their products, services, and/or content. Until users permit their information to be readily shared with the vendors, neither users nor the vendors will benefit from the user information.

Users' concern about privacy (e.g., tracking, unexplained observation and aggregation of data, etc.) is high and may adversely impact many vendors. A baseline of clear protections for users provides greater certainty for both users and vendors. As envisioned, user rights may include individual control, transparency, respect for context, security, access and accuracy, focused collection of data, and accountability. Users may have the right to exercise control over what user information vendors collect from the users and how the vendors use the user information. Users may also have the right to expect that the user information will be collected, used, and disclosed in ways that are consistent with a context in which the users provide the user information.

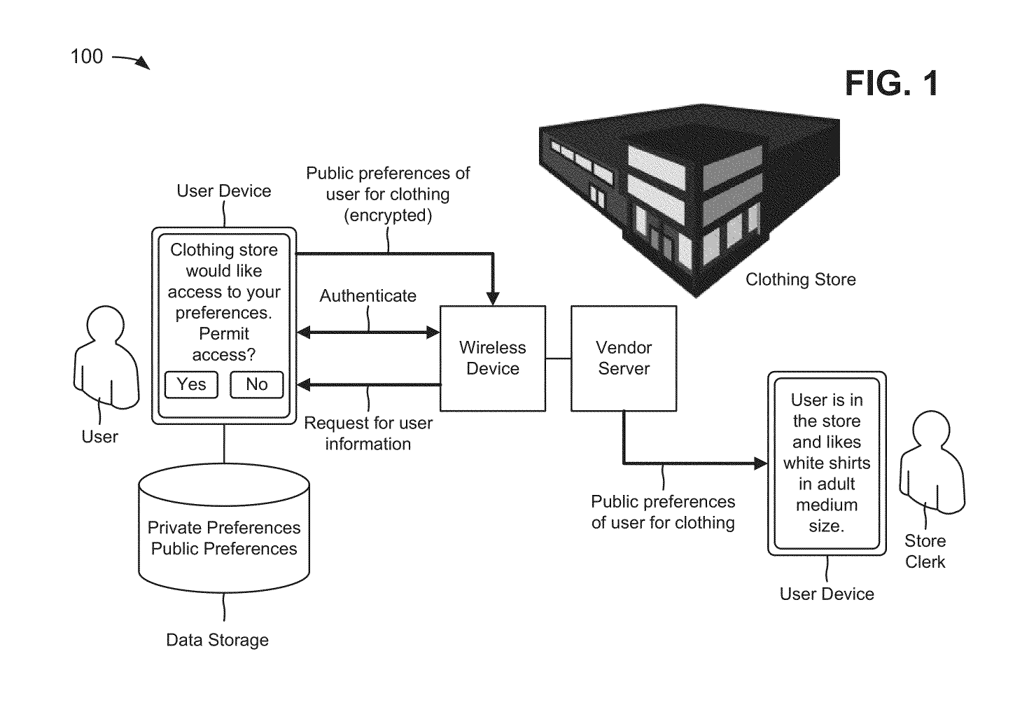

FIG. 1 is a diagram of an overview of an example implementation 100 described herein. In example implementation 100, assume that a user device (e.g., a smart phone) is associated with a user that plans on shopping at a clothing store. Further, assume that the user device includes data storage that stores a data structure (e.g., a tree, a table, a list, a database, etc.) with private preferences and/or public preferences associated with the user. The private preferences may include, for example, a name, a physical address, an email address, a telephone number, a credit card number, etc. associated with the user. The public preferences may include, for example, types of apparel preferred by the user (e.g., running shoes, collared shirts, etc.), the user's sizes for different types of apparel, types of food preferred by the user, etc.

As further shown in FIG. 1, the clothing store may include a vendor server (e.g., a computing device) connected to a wireless device that employs one or more short-range wireless communication protocols for a wireless personal area network (WPAN) and/or a wireless local area network (WLAN). As the user approaches the clothing store with the user device, the wireless device may detect the user device (e.g., via radio frequency (RF) signals generated by the user device). When the wireless device detects the user device, the vendor server may provide (e.g., via the wireless device) a request for user information to the user device. The user device may receive the request, and may display the request to the user. For example, as shown in FIG. 1, the user device may display a message inquiring whether the user wants to provide the clothing store with access to one or more of the user's preferences (e.g., “Clothing Store would like access to your preferences. Permit access?”).

Assume that the user instructs the user device (e.g., by selecting a “Yes” button) to provide, to the vendor server, the user's public preferences for clothing (e.g., the user likes white shirts in an adult medium size). Prior to providing the user's public preferences for clothing to the vendor server, the user device may authenticate the vendor server and/or the clothing store. For example, the user device may authenticate the vendor server and/or the clothing store by determining whether the clothing store is on a trusted vendor list, by requesting an authentication mechanism (e.g., a security key) from the vendor server and verifying the authentication mechanism, etc. If the vendor server and/or the clothing store are authenticated, the user device may provide the user's public preferences for clothing (e.g., via a cookie) to the vendor server, via the wireless device.

As further shown in FIG. 1, a store clerk at the clothing store may be associated with a user device (e.g., a tablet computer), and the vendor server may provide the user's public preferences for clothing to the store clerk's user device. The store clerk's user device may display information associated with the user's public preferences for clothing. For example, as shown, the store clerk's user device may display information indicating that the user is in the clothing store and information indicating that the user likes white shirts in an adult medium size. In some implementations, the user's user device may provide an image of the user to the vendor server, which may also be provided to the store clerk's user device. The image may enable the store clerk to visually locate the user in the clothing store and to direct the user to the clothing store's collection of adult medium white shirts.

Systems and/or methods described herein may enable a vendor to leverage preference information about a user to improve a quality of an interaction between the user and the vendor. The systems and/or methods may simplify communication of the user preferences from user devices to multiple vendor servers without the need for each vendor to create a proprietary system, application, database, etc. for the user preferences. The systems and/or methods may personalize a user's experience with vendors based on the user preferences, and may enable the user to control sharing of the user preferences, in a secure manner, with the vendors.

As used herein, the term user is intended to be broadly interpreted to include a user device, or a user of a user device. The term vendor, as used herein, is intended to be broadly interpreted to include a business, an organization, a government agency, a vendor server, a user of a vendor server, etc.

A product, as the term is used herein, is to be broadly interpreted to include anything that may be marketed or sold as a commodity or a good. For example, a product may include bread, coffee, bottled water, milk, soft drinks, pet food, beer, fuel, meat, fruit, automobiles, clothing, etc.

A service, as the term is used herein, is to be broadly interpreted to include any act or variety of work done for others (e.g., for compensation). For example, a service may include a repair service (e.g., for a product), a warranty (e.g., for a product), telecommunication services (e.g., telephone services, Internet services, network services, radio services, television services, video services, etc.), an automobile service (e.g., for selling automobiles), a food service (e.g., a restaurant), a banking service, a lodging service (e.g., a hotel), etc.

The term content, as used herein, is to be broadly interpreted to include video, audio, images, software downloads, and/or combinations of video, audio, images, and software downloads.

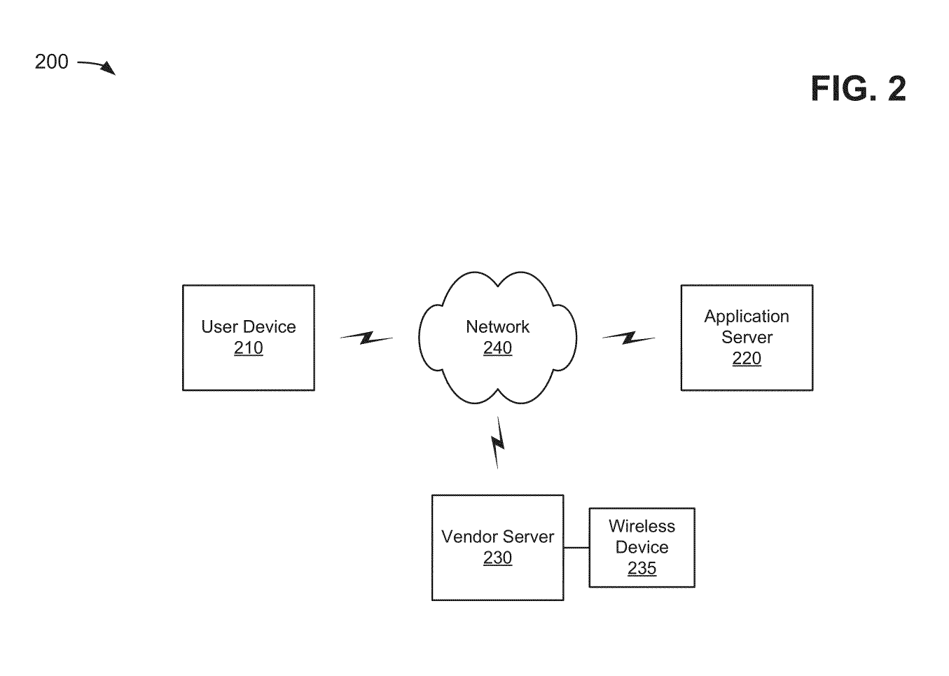

FIG. 2 is a diagram of an example environment 200 in which systems and/or methods described herein may be implemented. As illustrated, environment 200 may include a user device 210, an application server 220, a vendor server 230, a wireless device 235, and a network 240. Devices/networks of environment 200 may interconnect via wired connections, wireless connections, or a combination of wired and wireless connections.

User device 210 may include a device that is capable of communicating over network 240 with application server 220, vendor server 230, and/or wireless device 235. In some implementations, user device 210 may include a radiotelephone; a personal communications services (PCS) terminal that may combine, for example, a cellular radiotelephone with data processing and data communications capabilities; a smart phone; a personal digital assistant (PDA) that can include a radiotelephone, a pager, Internet/intranet access, etc.; a laptop computer; a tablet computer; a global positioning system (GPS) device; a gaming device; or another type of computation and communication device. In some implementations, user device 210 may include a favorites application that is downloaded from application server 220. The favorites application may enable a user of user device 210 to set preferences for creating, storing, and/or sharing private and/or public preferences associated with the user. In some implementations, the favorites application may be provided in application server 220, and user device 210 may access the favorites application from application server 220.

Application server 220 may include one or more personal computers, workstation computers, server devices, one or more virtual machines (VMs) provided in a cloud computing network, or other types of computation and communication devices. In some implementations, application server 220 may provide the favorites application to user device 210 upon request. In some implementations, application server 220 may store the favorites application, and user device 210 may access the favorites application from application server 220. In some implementations, the private and/or public preferences of the user may be stored in user device 210 and/or in application server 220.

Vendor server 230 may include one or more personal computers, workstation computers, server devices, or other types of computation and communication devices. In some implementations, vendor server 230 may be associated with a trusted vendor, such as, for example, a business, an organization, a government agency, etc. In some implementations, vendor server 230 may receive the private and/or public preferences of the user from user device 210 (e.g., upon request and authentication), and may utilize the private and/or public preferences of the user to provide offers for products, services, and/or content to user device 210. In some implementations, vendor server 230 may utilize the private and/or public preferences to provide, to employee(s) of the vendor, a notification indicating the private and/or public preferences of the user.

Wireless device 235 may include a wireless access point that employs one or more short-range wireless communication protocols for a wireless personal area network (WPAN) and/or a wireless local area network (WLAN), such as, for example, IEEE 802.15 (e.g., Bluetooth), IEEE 802.11 (e.g., Wi-Fi), near field communication (NFC), etc. In some implementations, wireless device 235 may connect to vendor server 230, and may enable vendor server 230 to communicate with user device 210. In some implementations, wireless device 235 may be incorporated within vendor server 230.

Network 240 may include a network, such as a local area network (LAN), a wide area network (WAN), a metropolitan area network (MAN), a telephone network, such as the Public Switched Telephone Network (PSTN) or a cellular network, an intranet, the Internet, a fiber optic network, a satellite network, a cloud computing network, or a combination of networks.

The number of devices and/or networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

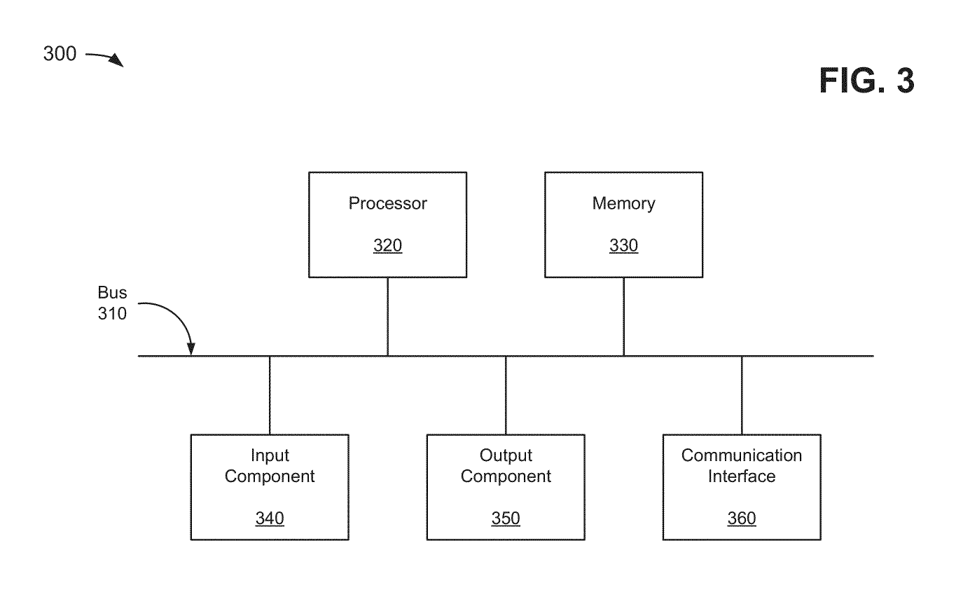

FIG. 3 is a diagram of example components of a device 300 that may correspond to one or more of the devices of environment 200. In some implementations, one or more of the devices of environment 200 may include one or more devices 300 or one or more components of device 300. As shown in FIG. 3, device 300 may include a bus 310, a processor 320, a memory 330, an input component 340, an output component 350, and a communication interface 360.

Bus 310 may include a path that permits communication among the components of device 300. Processor 320 may include a processor (e.g., a central processing unit, a graphics processing unit, an accelerated processing unit, etc.), a microprocessor, and/or any processing component (e.g., a field-programmable gate array (FPGA), an application-specific integrated circuit (ASIC), etc.) that interprets and/or executes instructions, and/or that is designed to implement a particular function. In some implementations, processor 320 may include multiple processor cores for parallel computing. Memory 330 may include a random access memory (RAM), a read only memory (ROM), and/or another type of dynamic or static storage component (e.g., a flash, magnetic, or optical memory) that stores information and/or instructions for use by processor 320.

Input component 340 may include a component that permits a user to input information to device 300 (e.g., a touch screen display, a keyboard, a keypad, a mouse, a button, a switch, etc.). Output component 350 may include a component that outputs information from device 300 (e.g., a display, a speaker, one or more light-emitting diodes (LEDs), etc.).

Communication interface 360 may include a transceiver-like component, such as a transceiver and/or a separate receiver and transmitter, which enables device 300 to communicate with other devices, such as via a wired connection, a wireless connection, or a combination of wired and wireless connections. For example, communication interface 360 may include an Ethernet interface, an optical interface, a coaxial interface, an infrared interface, a radio frequency (RF) interface, a universal serial bus (USB) interface, a high-definition multimedia interface (HDMI), or the like.

Device 300 may perform various operations described herein. Device 300 may perform these operations in response to processor 320 executing software instructions included in a computer-readable medium, such as memory 330. A computer-readable medium is defined as a non-transitory memory device. A memory device includes memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided as an example. In practice, device 300 may include additional components, fewer components, different components, or differently arranged components than those shown in FIG. 3. Additionally, or alternatively, one or more components of device 300 may perform one or more functions described as being performed by another one or more components of device 300.

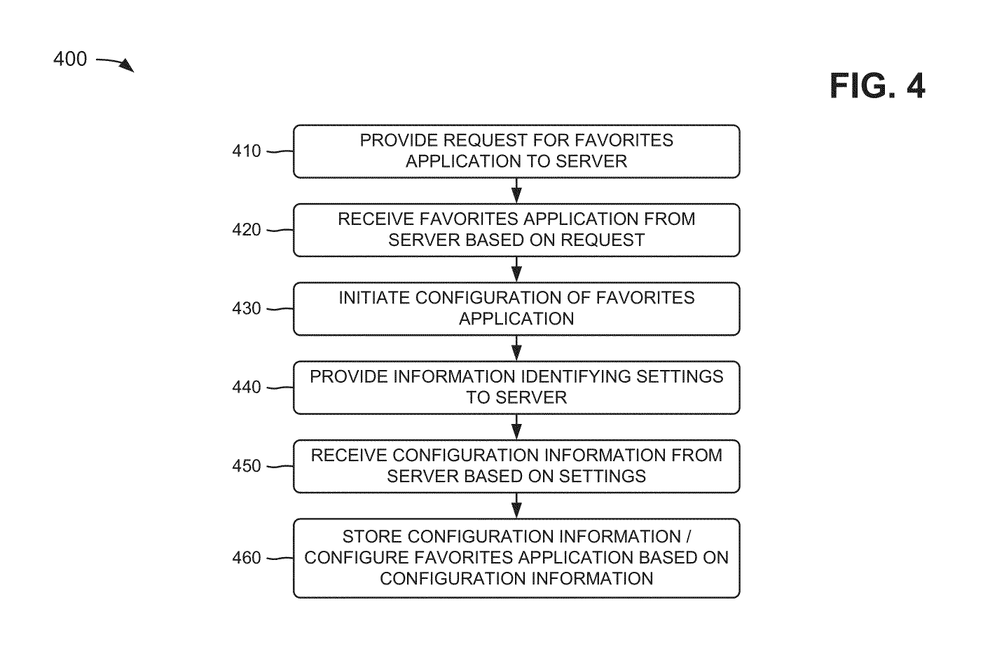

FIG. 4 is a flow chart of an example process 400 for receiving and configuring a favorites application for a user device. In some implementations, one or more process blocks of FIG. 4 may be performed by user device 210. In some implementations, one or more process blocks of FIG. 4 may be performed by another device or a group of devices separate from or including user device 210.

As shown in FIG. 4, process 400 may include providing a request for a favorites application to a server (block 410). For example, a user may cause user device 210 to provide a request for a favorites application to application server 220. In some implementations, the favorites application may include an application, a code snippet, a script, a widget, etc. that may cause user device 210 to perform one or more functions. For example, the favorites application may enable the user to set preferences for creating, storing, and/or sharing private and/or public preferences associated with the user. In some implementations, the user may cause user device 210 to access the favorites application (e.g., from applications server 220) via, for example, a user interface (such as a browser) or in another manner. The user may then select, using user device 210, information regarding the favorites application from the user interface to cause user device 210 to provide a request for the favorites application to application server 220. In some implementations, application server 220 may store the favorites application, and user device 210 may set preferences for the favorites application (e.g., for creating, storing, and/or sharing private and/or public preferences associated with the user) via application server 220.

As further shown in FIG. 4, process 400 may include receiving the favorites application from the server based on the request (block 420). For example, user device 210 may receive the favorites application from application server 220, and may store the favorites application in a memory associated with user device 210 (e.g., memory 330, FIG. 3). In some implementations, the user, of user device 210, may establish an account associated with the favorites application prior to or after receiving the favorites application. In some implementations, the account may enable the user to store the private and/or public preferences of the user in application server 220. In some implementations, the favorites application and/or the private and/or public preferences of the user, if stored on user device 210, may be protected (e.g., password protected, via a screen lock, encrypted, etc.) in case user device 210 is lost or stolen.

As further shown in FIG. 4, process 400 may include initiating a configuration of the favorites application (block 430). For example, the user may initiate the favorites application and identify, using user device 210, one or more settings relating to creating, storing, and/or sharing private and/or public preferences associated with the user. In some implementations, the user may identify the one or more settings using one or more elements of a user interface provided by user device 210. The one or more elements may include, for example, one or more text input elements, one or more drop down menu elements, one or more checkbox elements, one or more radio button elements, and/or any other types of elements that may be used to receive information from the user.

In some implementations, the one or more settings may include a setting of the user with respect to providing access to the private and/or public preferences associated with the user. For example, the user may indicate that vendors may receive the user's private and/or public preferences after requesting and receiving permission; may indicate that trusted vendors may automatically receive the user's private and/or public preferences associated with the user; may indicate that the vendors may automatically receive the user's public preferences; etc.

In some implementations, the one or more settings may include a setting of the user with respect to private preferences of the user. For example, the user may input, as private preferences, a name, a home address, a telephone number, a shipping address, a credit card number, a bank account identifier, etc. associated with the user.

In some implementations, the one or more settings may include a setting of the user with respect to public preferences of the user. For example, the user may input categories for the public preferences of the user, such as, food, apparel, entertainment, etc. For each category, the user may input types and options associated with each category. For example, for the food category, the user may input coffee as a type and medium (size) with cream and sugar as options; for the apparel category, the user may input shirts as a type and adult small white shirts as options; etc.

In some implementations, the one or more settings may include a setting of the user with respect to privacy settings for the favorites application. For example, the user may indicate that the user does not wish to share the user's private preferences with any vendor unless the user specifically instructs the favorites application to share such preferences.

In some implementations, the one or more settings may include a setting of the user with respect to storing the user's private and/or public preferences. For example, the user may elect to store the user's private and/or public preferences in user device 210 (e.g., in memory 300, FIG. 3), in application server 220 (e.g., in a cloud computing network), or in user device 210 and application server 220.

In some implementations, a type of the account, of the user, associated with the favorites application may determine the quantity of settings that the user is able to specify. For example, the favorites application may enable the user to specify only a portion of the above settings or specify additional settings based on the type of the account with which the user is associated. In some implementations, the one or more settings of the favorites application may include any combination of the aforementioned settings.

As further shown in FIG. 4, process 400 may include providing information identifying one or more settings to the server (block 440). For example, the user may cause user device 210 to provide, to application server 220, information identifying the one or more settings relating to the user and provided during the configuration of the favorites application.

As further shown in FIG. 4, process 400 may include receiving configuration information from the server based on the settings (block 450). For example, user device 210 may receive, from application server 220, configuration information that may be used to configure the favorites application to cause user device 210 to create, store, and/or share private and/or public preferences associated with the user.

In some implementations, application server 220 may generate the configuration information, which may be used to configure the favorites application, based on the information identifying the one or more settings of the user. For example, the configuration information may include information that causes user device 210 to provide the favorites application with access to functionality of user device 210, such as, wireless network detection by user device 210, the user's private and/or public preferences stored in memory, a GPS location of user device 210, etc.

In some implementations, the configuration information may include information that causes user device 210 to provide vendor server 230 with access to the private and/or public preferences associated with the user. In some implementations, the configuration information may include information associated with the private preferences input by the user. In some implementations, the configuration information may include information associated with the public preferences input by the user. In some implementations, the configuration information may include information associated the privacy settings for the favorites application. In some implementations, the configuration information may include information associated with storing the user's private and/or public preferences (e.g., storing in user device 210 and/or application server 220).

In some implementations, the configuration information may be obtained from a data structure. In some implementations, application server 220 may provide, to user device 210, the configuration information independent of receiving the information identifying the one or more settings of the user. In some implementations, the configuration information of the favorites application may include any combination of the aforementioned configuration information.

As further shown in FIG. 4, process 400 may include storing the configuration information and configuring the favorites application based on the configuration information (block 460). For example, the user may cause user device 210 to store all or a portion of the configuration information received from application server 220. The favorites application may be configured based on storing all or a portion of the configuration information.

In some implementations, application server 220 may provide updates, to the configuration information, to user device 210 based on use of the favorites application by the user and/or by other users of user devices 210. For example, application server 220 may receive updates, to the configuration information, from one or more other users and may provide the received updates to user device 210. User device 210 may store the updates to the configuration information. In some implementations, application server 220 may provide the updates periodically based on a preference of the user and/or based on a time frequency determined by application server 220. In some implementations, application server 220 may determine whether to provide the updates based on the type of the account associated with the user.

In some implementations, vendor server 230 may provide, to user device 210, updates to the user's public preferences based on interactions between user device 210 (e.g., the favorites application) and vendor server 230. For example, vendor server 230 may receive a particular order (e.g., a hamburger with pickles) from a user of user device 210, and may generate a recommended update, to the user's public preferences (e.g., indicating that the user prefers a hamburger with pickles) based on the order. Vendor server 230 may provide the recommended update to user device 210, and the user may or may not instruct user device 210 to store the recommended update in the user's public information.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

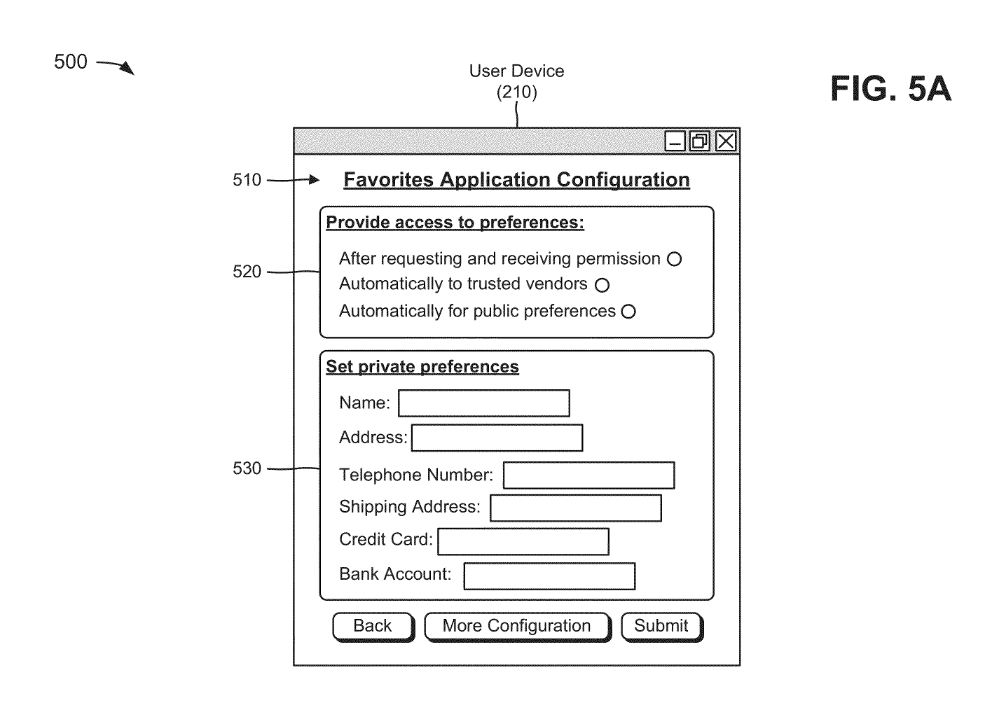

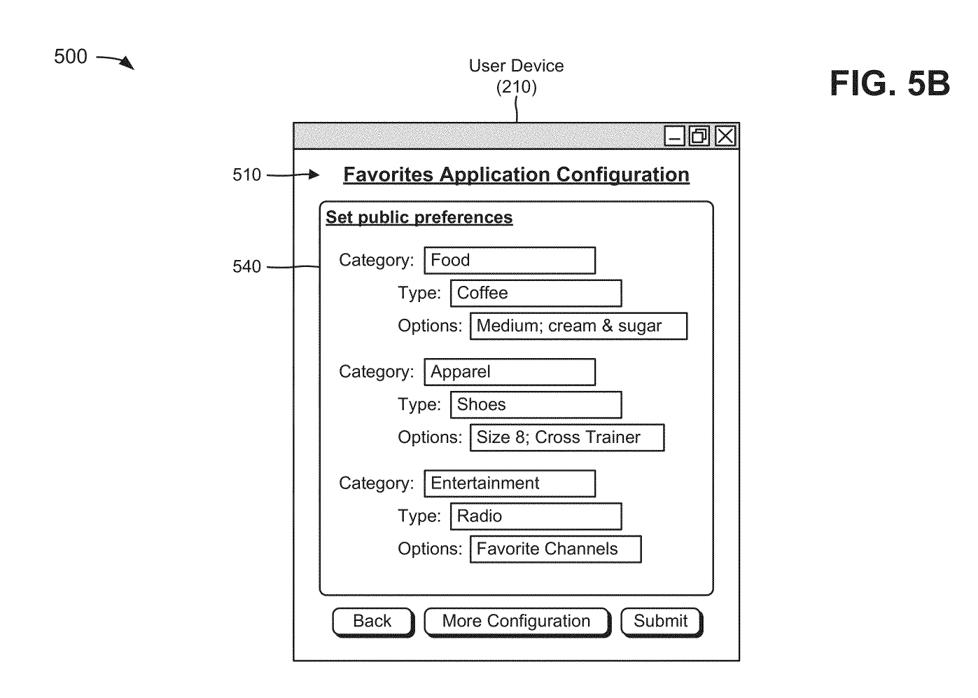

FIGS. 5A and 5B are diagrams 500 of an example user interface 510 that may be used in connection with example process 400 shown in FIG. 4. In some implementations, user interface 510 of FIGS. 5A and 5B may be provided by user device 210 to a user to enable the user to identify information (e.g., settings) that may be used to configure the favorites application so that user device 210 may create, store, and/or share private and/or public preferences associated with the user.

Assume that the user has previously caused user device 210 to request and download the favorites application. Further assume that the user causes user device 210 to install the favorites application on user device 210. When user device 210 installs the favorites application, as shown in FIG. 5A, application server 220 may provide user interface 510 to user device 210, and user device 210 may display user interface 510 to the user. User interface 510 may allow the user to configure different features of the favorites application. For example, the user may identify settings for providing access (e.g., to vendor server 230) to the user's private and/or public preferences in a first configuration section 520. In some implementations, the user may indicate that the user wants to provide vendor server 230 with access to the user's private and/or public preferences after vendor server 230 requests access and user device 210 approves the request for access. In some implementations, the user may indicate that the user wants to automatically provide trusted vendors (e.g., associated with vendor servers 220) with access to the user's private and/or public preferences. In some implementations, the user may indicate that the user wants to automatically provide the user's public preferences to vendor server 230 when requested by vendor server 230. In some implementations, the user may identify a level of access to provide to different types of vendors (e.g., allow a vendor to automatically access the user's preferences if the vendor can prove to be trustworthy, provide a notification to the user indicating that the vendor is requesting access, etc.).

As further shown in FIG. 5A, the user may set private preferences, associated with the user, in a second configuration section 530. In some implementations, the user may provide a name (e.g., John Doe); an address (e.g., 123 Jump Street, Fairfax, Va.); a telephone number (e.g., 111-222-3333); a shipping address (e.g., 342 Run Road, Wilmington, Del.); a credit card number (e.g., 9999-8888-7777-1111); a bank account identifier (e.g., 28145-1234); an email address (e.g., jdoe@website.com); a cell phone number (e.g., 444-555-6666); etc. associated with the user in second configuration section 530.

As shown in FIG. 5B, the user may set public preferences, associated with the user, in a third configuration section 540. In some implementations, the user may specify categories for the user's public preferences in third configuration section 540. For example, the user may specify categories, such as, food, apparel, entertainment, social media, content, etc. In some implementations, the user may specify types and options associated with each category. For example, for the food category, the user may specify a type (e.g., coffee) and options (e.g., medium coffee with cream and sugar); for the apparel category, the user may specify a type (e.g., shoes) and options (e.g., size 8 cross trainer shoes); for the entertainment category, the user may specify a type (e.g., radio) and options (e.g., favorite radio channels); etc.

In some implementations, the one or more settings of the favorites application may include any combination of the aforementioned settings. Once the user has identified the settings of the favorites application, user interface 510 may allow the user to select a “Submit” option to store the settings and/or submit the settings to application server 220. Application server 220 may then provide, to user device 210, configuration information based on the settings.

As further shown in FIGS. 5A and 5B, user interface 510 may also allow the user to select a “Back” option to cause user device 210 to provide information regarding the favorites application. As also shown in FIGS. 5A and 5B, user interface 510 may also allow the user to select a “More Configuration” option to enable the user to identify additional information that may be used to configure the favorites application.

The number of elements of user interface 510 shown in FIGS. 5A and 5B is provided for explanatory purposes. In practice, user interface 510 may include additional elements, fewer elements, different elements, or differently arranged elements than those shown in FIGS. 5A and 5B.

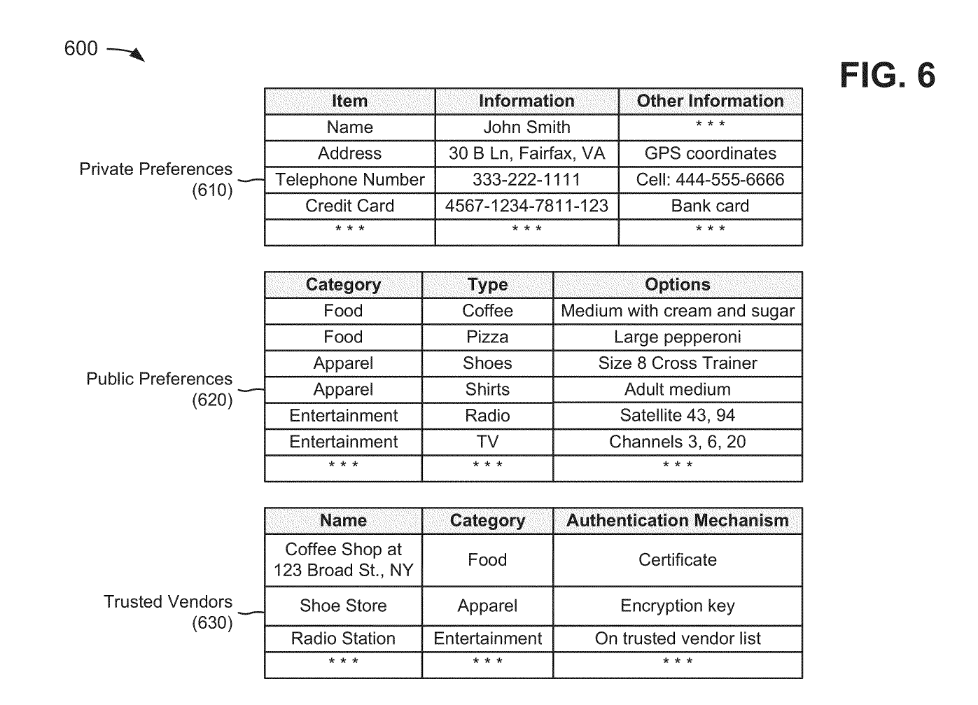

FIG. 6 is a diagram of an example data structure 600 that stores private preferences 610, public preferences 620, and trusted vendors information 630 associated with a user of user device 210. In some implementations, data structure 600 may be stored in memory (e.g., memory 330, FIG. 3) associated with user device 210 and/or application server 220. In some implementations, one or more portions of data structure 600 may be stored in memory associated with vendor server 230 if the user of user device 210 elects to share the one or more portions of data structure 600 with vendor server 230.

As shown in FIG. 6, private preferences 610 may include an item field, an information field, an other information field, and one or more entries associated with each of the fields. The item field may include one or more entries identifying private information associated with the user. For example, the item field may include entries for a name, an address, a telephone number, a credit card number, an email address, a shipping address, etc. associated with the user.

The information field may include entries that provide information corresponding to the entries provided in the item field. For example, the information field may indicate that the name of the user is “John Smith,” that the address of the user is “30 B Lane, Fairfax, Va.,” that the telephone number of the user is “333-222-1111,” that the credit card number of the user is “4567-1234-7811-123.” etc. The other information field may include entries that provide other information corresponding to the entries provided in the item field. For example, the other information field may provide the address of the user via GPS coordinates, a cell number of the user is (e.g., 444-555-6666), information identifying the credit card (e.g. a card issued by a bank), etc. In some implementations, private preferences 610 or public preferences 620 may include an image of the user which may be shared with vendor server 230 (e.g., so that a vendor may visually identify the user) with the user's permission.

As further shown in FIG. 6, public preferences 620 may include a category field, a type field, an options field, and one or more entries associated with each of the fields. The category field may include one or more entries identifying categories for public preferences 620. For example, the category field may include entries for food, apparel, entertainment, social media, etc. The type field may include entries that provide type information corresponding to the entries provided in the category field. For example, the type field may include entries for coffee and pizza that are associated with the food category, entries for shoes and shirts that are associated with the apparel category, entries for radio and television (TV) that are associated with the entertainment category, etc. The options field may include entries that provide information identifying the user's preferences for the entries identified in the type field. For example, the options field may indicate that the user prefers a medium coffee with cream sugar, a large pepperoni pizza, size 8 cross trainer shoes, an adult medium shirt, satellite radio stations 43 and 94, television channels 3, 6, and 20, etc.

As further shown in FIG. 6, trusted vendors information 630 may include a name field, a category field, an authentication mechanism field, and one or more entries associated with each of the fields. The name field may include one or more entries identifying names of trusted vendors. A trusted vendor may include a vendor identified as being particularly trustworthy (e.g., a vendor provided in a white list of trusted vendors, vendor server 230 with whom user device 210 has exchanged authentication mechanisms, such as keys, certificates, etc.). For example, the name field may include entries for a coffee shop, a shoe store, a radio station, etc. The category field may include one or more entries identifying categories for the trusted vendors identified in the name field. For example, the category field may include entries for food, apparel, entertainment, social media, etc. The authentication mechanism field may include entries that provide type information corresponding to an authentication mechanism used to authenticate the trusted vendors. For example, the authentication mechanism field may include an entry for a certificate for the coffee shop, an entry for an encryption key for the shoe store, an entry for a trusted vendor list (e.g., a white list) for the radio station, etc.

Data structure 600 includes private preferences 610, public preferences 620, and trusted vendors information 630 for explanatory purposes. In some implementations, data structure 600 may include additional preferences and/or trusted vendor information, fewer preferences and/or trusted vendor information, different preferences and/or trusted vendor information, or differently arranged preferences and/or trusted vendor information than those shown in FIG. 6 and/or described herein with respect to data structure 600. In some implementations, data structure 600 may include additional fields, fewer fields, different fields, or differently arranged fields than those shown in FIG. 6 and/or described herein with respect to data structure 600. Furthermore, while data structure 600 is represented as a table with rows and columns, in some implementations, data structure 600 may include any type of data structure, such as a tree structure, a linked list, a hash table, a database, or any other type of data structure.

In some implementations, data structure 600 may include information generated by a device and/or a component. Additionally, or alternatively, data structure 600 may include information provided from another source, such as information provided by a user and/or information automatically provided by a device. In some implementations, data structure 600 may be populated with entries as the user utilizes user device 210 to interact with vendors and/or vendor servers 230. For example, if the user utilizes user device 210 to buy a pizza at the user's favorite pizza shop, user device 210 may provide entries associated with the pizza shop and/or the type of pizza ordered in data structure 600. In some implementations, vendor server 230 at the pizza shop may provide the entries associated with the pizza shop and/or the type of pizza ordered, to user device 210, and user device 210 may store the entries in data structure 600.

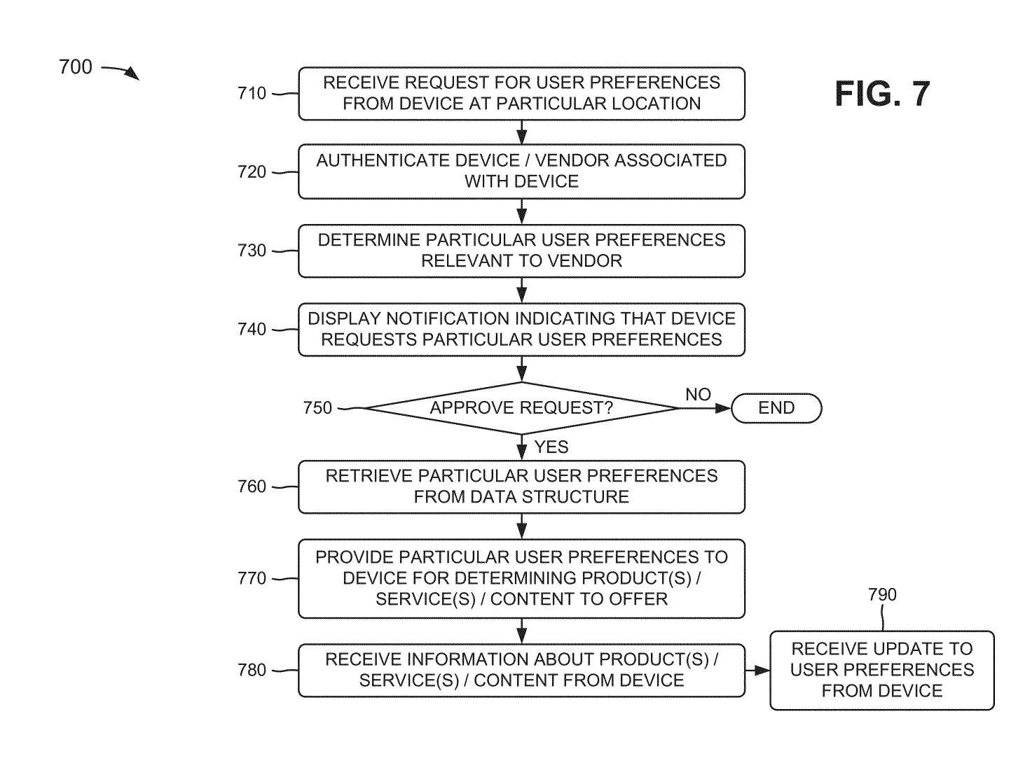

FIG. 7 is a flow chart of an example process 700 for securely providing user preferences to a vendor server. In some implementations, one or more process blocks of FIG. 7 may be performed by user device 210 (e.g., via the favorites application). In some implementations, one or more process blocks of FIG. 7 may be performed by another device or a group of devices separate from or including user device 210, such as application server 220.

As shown in FIG. 7, process 700 may include receiving a request for user preferences from a device at a particular location (block 710). For example, assume that a user approaches a vendor's establishment (e.g., a store) with user device 210, and that wireless device 235 detects user device 210 (e.g., via RF signals generated by user device 210). In some implementations, when wireless device 235 detects user device 210, vendor server 230 may determine that the user is a potential customer of the vendor, and may generate a request for user preferences so that the vendor may learn more about the user. Vendor server 230 may provide (e.g., via wireless device 235) the request for user preferences to user device 210, and user device 210 may receive the request. In some implementations, the request may be generated by other devices, such as, for example, a radio in the user's car, a television in the user's home, a home monitoring system, etc.

As further shown in FIG. 7, process 700 may include authenticating the device and/or the vendor associated with the device (block 720). For example, user device 210 may authenticate vendor server 230 and/or the vendor associated with vendor server 230 based on the request and an authentication mechanism. In some implementations, user device 210 may authenticate vendor server 230 and/or the vendor by determining whether the vendor is identified in trusted vendors information 630 provided in data structure 600. In some implementations, user device 210 may authenticate vendor server 230 and/or the vendor by determining whether the vendor is provided in a white list of vendors determined to be particularly trustworthy. In some implementations, user device 210 may authenticate vendor server 230 and/or the vendor by requesting and receiving a certificate from vendor server 230 (e.g., that verifies the vendor as trustworthy). In some implementations, user device 210 may authenticate vendor server 230 and/or the vendor by requesting and receiving a key from vendor server 230 (e.g., that verifies the vendor as trustworthy). In some implementations, user device 210 may authenticate vendor server 230 and/or the vendor via other authentication mechanisms (e.g., via a security token, a password, a pass phrase, a challenge response, etc.).

As further shown in FIG. 7, process 700 may include determining particular user preferences that are relevant to the vendor (block 730). For example, user device 210 may determine one or more private and/or public preferences, associated with the user, that are relevant to the vendor. In some implementations, the user may identify, via user device 210, one or more of the user's private and/or public preferences that the user considers relevant to the vendor. In some implementations, user device 210 may determine a category associated with the vendor based on information provided by the vendor via the request for user preferences. In some implementations, the request may include information identifying the vendor as a clothing store, a restaurant, a coffee shop, a sporting goods store, an electronics store, an appliance store, etc. In some implementations, the request may include information identifying other devices, such as, for example, a radio in the user's car, a television in the user's home, a home monitoring system, etc. In some implementations, the request may include information identifying a name of the vendor. In such implementations, user device 210 may utilize the name of the vendor to identify a category associated with the vendor from trusted vendors information 630 (FIG. 6). For example, if user device 210 determines that the vendor is a shoe store, user device 210 may determine (e.g., from trusted vendors information 630) that the vendor is associated with an apparel category.

In some implementations, user device 210 may utilize the request and/or the category associated with the vendor to identify a type and options associated with the vendor from public preferences 620 (FIG. 6). For example, if user device 210 determines that the vendor is a coffee shop and is associated with a food category, user device 210 may determine that the vendor is associated with coffee (e.g., a type) and that the user likes a medium coffee with cream and sugar (e.g., options). In such an example, user device 210 may determine that the options (e.g., a medium coffee with cream and sugar) are the particular user preferences that are relevant to the vendor (e.g., the coffee shop).

In some implementations, user device 210 may utilize the request and/or the category associated with the vendor to identify information, from private preferences 610 (FIG. 6), as the particular user preferences that are relevant to the vendor. For example, assume that user device 210 determines that the vendor is an electronics store and is associated with an entertainment category. Further, assume that the user wishes to purchase a stereo from the electronics store and is willing to share the user's credit card number with the electronics store. In such an example, user device 210 may identify the user's credit card number, from private preferences 610, as the particular user preferences that are relevant to the vendor (e.g., the electronics store).

As further shown in FIG. 7, process 700 may include displaying a notification indicating that the device requests the particular user preferences (block 740). For example, user device 210 may display, based on the request for user preferences, a notification indicating that vendor server 230 requests the particular user preferences from user device 210. In some implementations, user device 210 may display the notification when the request is received and prior to authenticating the vendor and/or vendor server 230 and determining the particular user preferences. In some implementations, user device 210 may display, in the notification, information indicating that the vendor (e.g., vendor server 230) requests access to the user's private and/or public preferences, and information requesting whether the user wishes to provide the vendor with the access to the user's private and/or public preferences. For example, if the vendor is a restaurant, user device 210 may display information indicating that the restaurant requests access to the user's favorite types of meals served by the restaurant, and information requesting whether the user wishes to provide the restaurant access to the user's favorite types of meals.

In some implementations, user device 210 may not display a notification if the user configured the favorites application to automatically provide the user's public preferences to trusted vendors upon request. For example, assume that the user configured the favorites application to provide information identifying the user's favorite sports apparel when the user enters into a sporting goods store, and that the user enters a sporting goods store with user device 210. In such an example, user device 210 may not display a notification to the user, but may automatically provide the information identifying the user's favorite sports apparel to vendor server 230, associated with the sporting goods store, upon request from vendor server 230. In some implementations, user device 210 may not display a notification, and may automatically provide the user's public preferences to trusted vendors when user device 210 is detected by the trusted vendors (e.g., without the trusted vendors requesting the user's public preferences).

As further shown in FIG. 7, process 700 may include determining whether the request is approved based on the notification (block 750). For example, user device 210 may determine whether the request for the user preferences is approved based on the notification displayed by user device 210. In some implementations, user device 210 may determine whether the request for the user preferences is approved based on how the user responds (e.g., via user device 210) to the information requesting whether the user wishes to provide the vendor with the access to the user's private and/or public preferences. For example, the information requesting whether the user wishes to provide the vendor with the access to the user's private and/or public preferences may include an approval mechanism (e.g., a “Yes” button, icon, link, etc.) that, when selected, indicates that the user approves the request; and a disapproval mechanism (e.g., a “No” button, icon, link, etc.) that, when selected, indicates that the user disapproves the request. In some implementations, user device 210 may display information indicating that user device 210 is about to provide the vendor particular information (e.g., a name, an address, and food preferences), and inquire whether the user wishes to provide the particular information. If the user does not wish to provide all of the particular information, the user may select which of the particular information to provide to the vendor.

As further shown in FIG. 7, if the request is not approved (block 750—NO), process 700 may end. For example, if user device 210 determines that the request for the user preferences is not approved, user device 210 may disregard the request. In some implementations, user device 210 may provide, to vendor server 230, a message indicating that the request for the user preferences has been denied by user device 210. In some implementations, user device 210 may determine that the request for the user preferences is not approved when the user selects (e.g., via user device 210) the disapproval mechanism (e.g., the “No” button, icon, link, etc.).

As further shown in FIG. 7, if the request is approved (block 750—YES), process 700 may include retrieving the particular user preferences from a data structure (block 760). For example, if user device 210 determines that the request for the user preferences is approved, user device 210 may retrieve the particular user preferences from a data structure (e.g., data structure 600, FIG. 6). In some implementations, user device 210 may determine that the request for the user preferences is approved when the user selects (e.g., via user device 210) the approval mechanism (e.g., the “Yes” button, icon, link, etc.). In some implementations, user device 210 may retrieve the particular user preferences from private preferences 610 and/or public preferences 620 of data structure 600 (FIG. 6). For example, as described above, if user device 210 determines that options (e.g., a medium coffee with cream and sugar) are the particular user preferences that are relevant to a vendor (e.g., a coffee shop), user device 210 may retrieve the options from public preferences 620. In another example, as described above, if user device 210 determines that the user's credit card number is the particular user preferences that are relevant to a vendor (e.g., an electronics store), user device 210 may retrieve the user's credit card number from private preferences 610.

As further shown in FIG. 7, process 700 may include providing the particular user preferences to the device for determining one or more products, services, and/or content to offer (block 770). For example, user device 210 may provide the particular user preferences to vendor server 230. In some implementations, vendor server 230 may provide the particular user preferences to a user device 210 associated with the vendor. For example, assume that a user enters a clothing store with user device 210, and that user device 210 provides, as the particular user preferences, an image of the user and information indicating that the user prefers adult medium blue jeans to vendor server 230. In such an example, vendor server 230 may provide the image of the user and the information indicating that the user prefers adult medium blue jeans to a user device 210 associated with a store employee. The store employee's user device 210 may display the image of the user the user's preference for adult medium blue jeans to the store employee. The store employee may locate the user (e.g., based on the image of the user), and may direct the user to adult medium blue jeans (e.g., based on the user's preference).

In another example, assume that a user enters a sandwich shop with user device 210, and that user device 210 provides, as the particular user preferences, a name of the user and information indicating that the user wants to order a ham sandwich to vendor server 230. In such an example, vendor server 230 may provide the name of the user and the information indicating that the user wants a ham sandwich to a user device 210 associated with a shop employee. The shop employee's user device 210 may display the name of the user and the user's order for the ham sandwich to the shop employee. The shop employee may make a ham sandwich for the user (e.g., based on the user's preferences), and the user may pay for and receive the ham sandwich more quickly from the sandwich shop (e.g., based on the user's name).

In some implementations, vendor server 230 may determine one or more products, services, and/or content to offer to the user based on the particular user preferences. Using the example described above, vendor server 230 may determine that a particular brand of blue jeans are on sale at the clothing store based on the user's preference for adult medium blue jeans. In some implementations, vendor server 230 may provide information associated with the particular brand of blue jeans to the store employee's user device 210 so that the store employee may direct the user to the particular brand of blue jeans. In some implementations, vendor server 230 may provide information associated with the particular brand of blue jeans to the user's user device 210 (e.g., indicating that “Brand X jeans are on sale in aisle 5”) so that the user may be directed to the particular brand of blue jeans.

As further shown in FIG. 7, process 700 may include receiving information about the one or more products, services, and/or content from the device (block 780). For example, user device 210 may receive, from vendor server 230, information associated with one or more products, services, and/or content offered by the vendor. In some implementations, the one or more products, services, and/or content may be customized based on the particular user preferences provided by user device 210 to vendor server 230. For example, assume that the user and user device 210 are physically located near a supermarket, and that user device 210 provides, as the particular user preferences, an image of the user and information indicating that the user prefers a particular brand of soda to vendor server 230. In such an example, vendor server 230 may determine that the particular brand of soda is available at the supermarket based on the user's preference for brand of soda.

In some implementations, vendor server 230 may provide the image of the user and information associated with the particular brand of soda to a user device 210 associated with a supermarket employee so that the supermarket employee may direct the user to the particular brand of soda (e.g., if the user enters the supermarket). In some implementations, vendor server 230 may provide information associated with the particular brand of soda to the user's user device 210 (e.g., indicating that “Soda Brand Y is located in aisle 8”) so that the user may be directed to the particular brand of soda (e.g., if the user enters the supermarket).

As further shown in FIG. 7, process 700 may include receiving an update to the user preferences from the device (block 790). For example, user device 210 may receive an update to the user's private and/or public information from vendor server 230. In some implementations, vendor server 230 may determine the update to the user's private and/or public information based on the user's interactions with the vendor. For example, assume that the user utilizes user device 210 (e.g., an application stored on user device 210) at a fast food restaurant to order a hamburger, French fries, and a soda. Further, assume that the user utilizes a mobile wallet application on user device 210 to pay for the order. In such an example, vendor server 230 (e.g., associated with the fast food restaurant) may provide, to user device 210, an update indicating that the user prefers a hamburger, French fries, and a soda and prefers to pay via the mobile wallet application. User device 210 may request whether the user wants to accept or decline the update to the user's private and/or public preferences for this particular vendor (e.g., the fast food restaurant). If the user accepts the update, user device 210 may update data structure 600 (FIG. 6) to indicate that the user prefers a hamburger, French fries, and a soda from the fast food restaurant, and that the user prefers to pay the fast food restaurant via the mobile wallet application. The next time that the user enters or is near the fast food restaurant, user device 210 may display a notification requesting whether the user wants to order a hamburger, French fries, and a soda from the fast food restaurant. If the user agrees to place an order, user device 210 may instruct vendor server 230 to place the order and pay for the order via the mobile wallet application. The user may then approach a counter of the fast food restaurant, show an order number, and receive the order.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

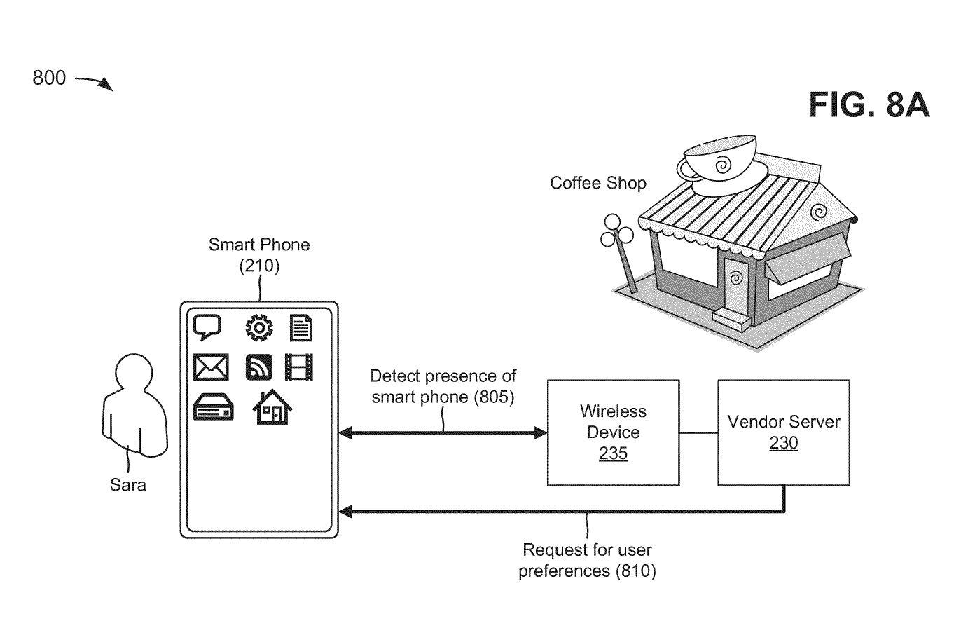

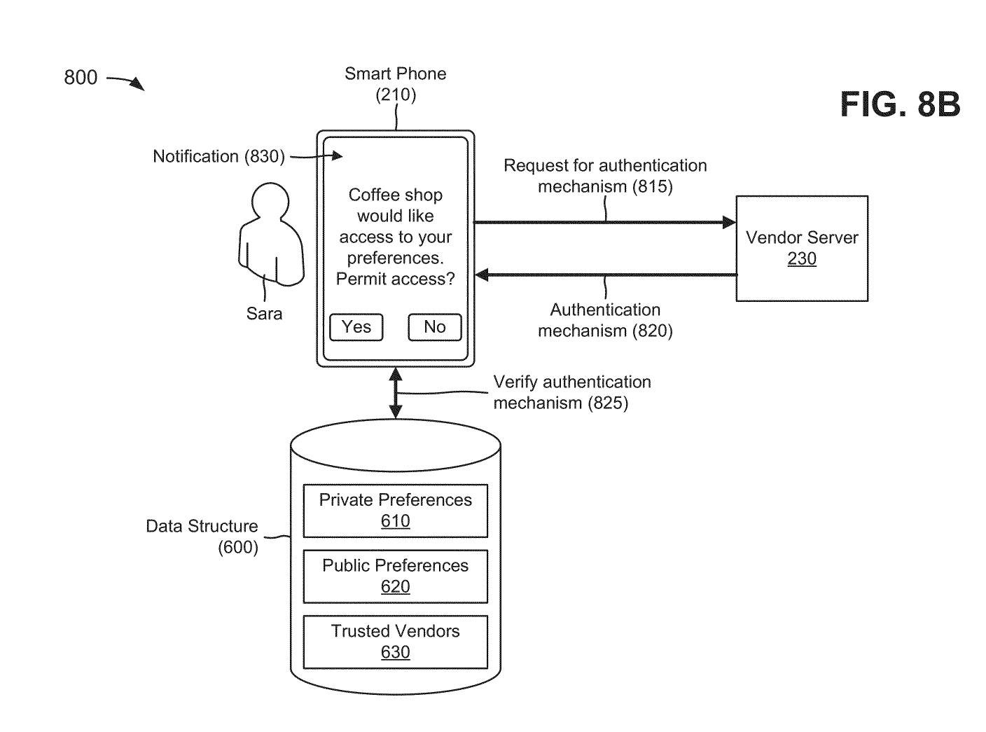

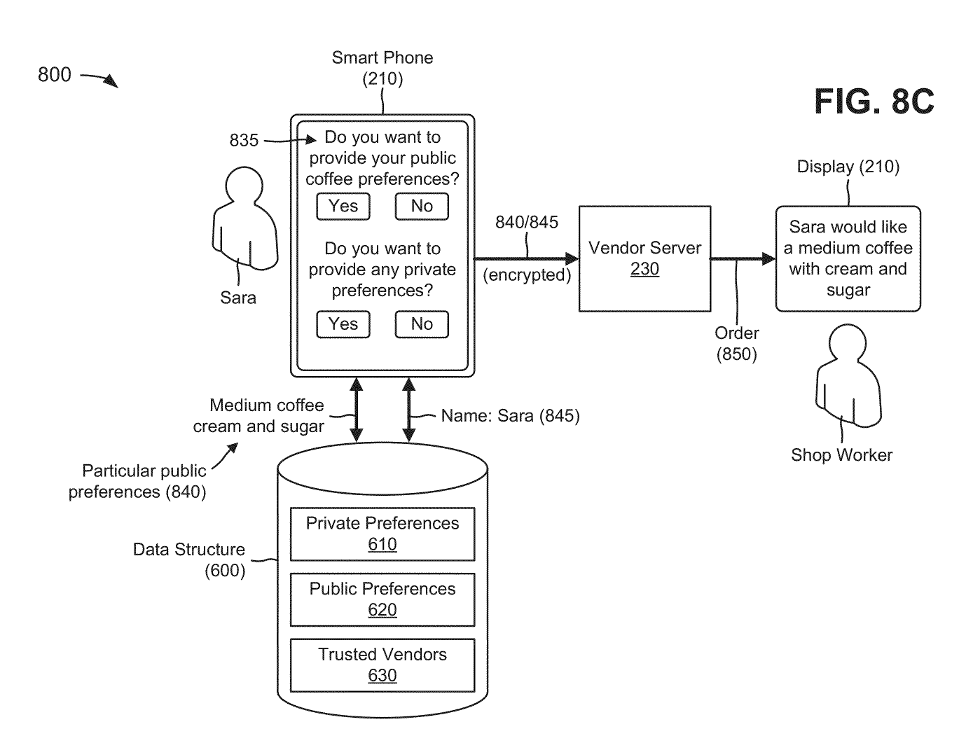

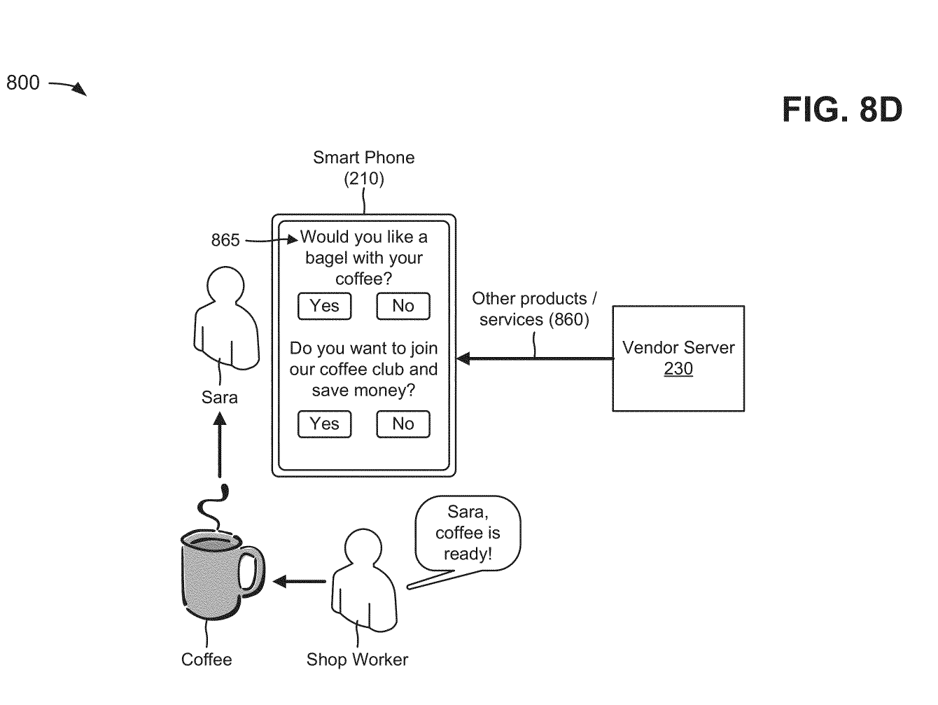

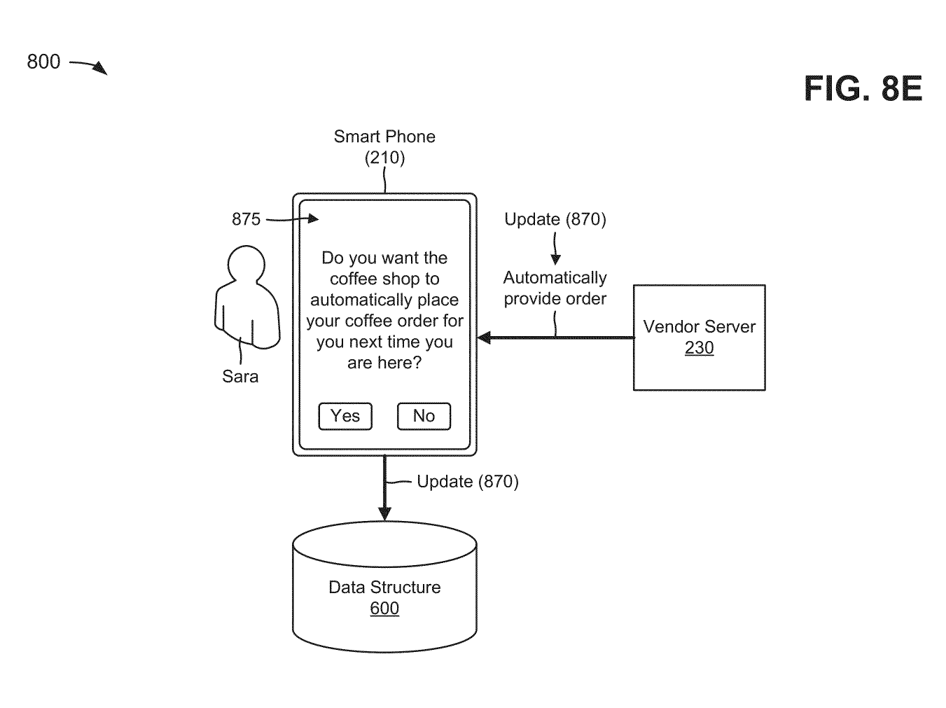

FIGS. 8A-8E are diagrams of an example 800 relating to example process 700 shown in FIG. 7. For the purpose of example 800, assume that a user (e.g., Sara) is associated with user device 210 (e.g., a smart phone 210), and that Sara enters or is physically located near a coffee shop with smart phone 210, as shown in FIG. 8A. Further, assume that the coffee shop is associated with vendor server 230 and wireless device 235, and that wireless device 235 detects the presence of smart phone 210 (e.g., via RF signals generated by smart phone 210), as indicated by reference number 805 in FIG. 8A. When wireless device 235 detects smart phone 210, wireless device 235 may notify vendor server 230 that Sara and smart phone 210 have entered or are near the coffee shop. Vendor server 230 may provide a request 810 for user preferences to smart phone 210, and smart phone 210 may receive request 810, as further shown in FIG. 8A. Request 810 may include information indicating that vendor server 230 would like access to one or more of Sara's private and/or public preferences.

As shown in FIG. 8B, smart phone 210 may provide a request 815 for an authentication mechanism (e.g., a key, a certificate, etc.) to vendor server 230 based on request 810. Smart phone 210 may receive an authentication mechanism 820 (e.g., a key, a certificate, etc.) from vendor server 230 based on request 815. Smart phone 210 may verify authentication mechanism 820, as indicated by reference number 825 in FIG. 8B, by comparing authentication mechanism 820 to, or processing authentication mechanism 820 with trusted vendors information 630 in data structure 600. For example, smart phone 210 may determine whether authentication mechanism 820 matches an authentication mechanism for a vendor listed in trusted vendors information 630. Assuming that smart phone 210 verifies authentication mechanism 820, smart phone 210 may display a notification 830 to Sara, as further shown in FIG. 8B. Notification 830 may indicate that the coffee shop would like access to Sara's preferences, and may request that Sara approve or disapprove of the coffee shop accessing Sara's preferences (e.g., via “Yes” and “No” buttons, icons, links, etc.).

Sara may instruct smart phone 210 (e.g., via selection of the “Yes” button) to provide the coffee shop with access to some of her preferences, and smart phone 210 may display a user interface 835 to Sara, as shown in FIG. 8C. User interface 835 may request that Sara approve or disapprove of the coffee shop accessing Sara's public and private preferences (e.g., via “Yes” and “No” buttons, icons, links, etc.). Assume that Sara instructs smart phone 210 (e.g., via selection of the “Yes” button) to provide the coffee shop with access to particular public preferences 840 (e.g., a medium coffee with cream and sugar) and to particular private preferences 845 (e.g., Sara's name). Smart phone 210 may retrieve particular public preferences 840 from public preferences 620 of data structure 600, and may retrieve particular private preferences 845 from private preferences 610 of data structure 600.

As further shown in FIG. 8C, smart phone 210 may provide (e.g., in an encrypted format) particular public preferences 840 and particular private preferences 845 to vendor server 230, and vendor server 230 may decrypt particular public preferences 840 and particular private preferences 845. Vendor server 230 may generate an order 850 based on particular public preferences 840 and particular private preferences 845, and may provide order 850 to user device 210 (e.g., a display 210) associated with a coffee shop worker. Display 210 may display order 850 to the shop worker so that the shop worker may fulfill order 850. As shown in FIG. 8C, order 850 may indicate that Sara wants a medium coffee with cream and sugar.

The shop worker may prepare the medium coffee with cream and sugar, and may indicate to Sara that her coffee is ready, as shown in FIG. 8D. Sara may pay the shop worker for the coffee via smart phone 210 or via other means (e.g., credit card, debit card, cash, etc.). As further shown in FIG. 8D, vendor server 230 may determine information 860 associated with other products, services, and/or content to offer to Sara based on order 850, particular public preferences 840, and/or particular private preferences 845, and may provide information 860 to smart phone 210. Smart phone 210 may display information 860 in a user interface 865 to Sara. User interface 865 may inquire whether Sara wants a bagel with her coffee and/or whether Sara wants to join the coffee shop's coffee club and save money. Sara may indicate whether she wants the bagel and/or to join the coffee club via user interface 865 (e.g., via “Yes” and “No” buttons, icons, links, etc.).

As shown in FIG. 8E, vendor server 230 may determine an update 870 to Sara's preferences based on order 850 (e.g., automatically provide the order the next time that Sara is near the coffee shop), and may provide update 870 to smart phone 210. Smart phone 210 may display update 870 in a user interface 875 to Sara. User interface 875 may inquire whether Sara wants the coffee shop to automatically place Sara's coffee order the next time that Sara and smart phone 210 are physically located at or near the coffee shop. Sara may indicate whether she wants the coffee shop to automatically place Sara's coffee order the next time via user interface 875 (e.g., via “Yes” and “No” buttons, icons, links, etc.). If Sara agrees to have the coffee shop automatically place her coffee order the next time (e.g., via selection of the “Yes” button), smart phone 210 may provide update 870 to data structure 600, as further shown in FIG. 8E. For example, smart phone 210 may update Sara's preferences to indicate that vendor server 230 is to automatically place Sara's coffee order the next time that Sara and smart phone 210 are at or near the coffee shop.

As indicated above, FIGS. 8A-8E are provided merely as an example. Other examples are possible and may differ from what was described with regard to FIGS. 8A-8E. In some implementations, information provided by the user interfaces depicted in FIGS. 8A-8E may include textual information and/or an audible form of the textual information.

Systems and/or methods described herein may enable a vendor to leverage preference information about a user to improve a quality of an interaction between the user and the vendor. The systems and/or methods may simplify communication of the user preferences from user devices to multiple vendor servers without the need for each vendor to create a proprietary system, application, database, etc. for the user preferences. The systems and/or methods may personalize a user's experience with vendors based on the user preferences, and may enable the user to control sharing of the user preferences, in a secure manner, with the vendors.

To the extent the aforementioned implementations collect, store, or employ personal information provided by individuals, it should be understood that such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The foregoing disclosure provides illustration and description, but is not intended to be exhaustive or to limit the implementations to the precise form disclosed. Modifications and variations are possible in light of the above disclosure or may be acquired from practice of the implementations.

A component is intended to be broadly construed as hardware, firmware, or a combination of hardware and software.

User interfaces may include graphical user interfaces (GUIs) and/or non-graphical user interfaces, such as text-based interfaces. The user interfaces may provide information to users via customized interfaces (e.g., proprietary interfaces) and/or other types of interfaces (e.g., browser-based interfaces, etc.). The user interfaces may receive user inputs via one or more input devices, may be user-configurable (e.g., a user may change the sizes of the user interfaces, information displayed in the user interfaces, color schemes used by the user interfaces, positions of text, images, icons, windows, etc., in the user interfaces, etc.), and/or may not be user-configurable. Information associated with the user interfaces may be selected and/or manipulated by a user (e.g., via a touch screen display, a mouse, a keyboard, a keypad, voice commands, etc.).

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method, comprising:
receiving, by a user device and from a device, a request for user preferences associated with a user of the user device,
the user preferences being stored in memory associated with the user device;
authenticating, by the user device, a vendor associated with the device;
determining, by the user device, one or more particular user preferences, from the user preferences, that are relevant to the vendor;
approving, by the user device, the request for the user preferences when the user device determines that the vendor is authenticated;
retrieving, by the user device, the one or more particular user preferences from the memory based on the approval of the request for the user preferences; and
providing, by the user device, the one or more particular user preferences to the device,
the one or more particular user preferences being used to determine one or more products, services, or content, of the vendor, to offer to the user.

2. The method of claim 1, further comprising:
disapproving the request for the user preferences when the user device determines that the vendor is not authenticated; and
providing a message to the device indicating that the request for the user preferences is disapproved.

3. The method of claim 1, further comprising:
receiving, from the device, information associated with the one or more products, services, or content to offer to the user; and
presenting, for display, the information associated with the one or more products, services, or content to offer to the user.

4. The method of claim 1, further comprising:
receiving an update to the user preferences from the device; and
storing the update to the user preferences in the memory.

5. The method of claim 1, where the memory is provided in one of:
the user device, or
a server device accessible by the user device.

6. The method of claim 1, where the request for the user preferences includes:
information identifying the vendor, and
information requesting user preferences relevant to the vendor.

7. The method of claim 1, where the memory stores one or more of:
information associated with public preferences of the user,
information associated with private preferences of the user, or
information associated with trusted vendors.

8. A user device, comprising:
a memory; and
one or more processors to:
receive, from a device associated with a vendor, a request for user preferences associated with a user of the user device,
the user preferences being stored in the memory;
authenticate the vendor associated with the device;
determine one or more particular user preferences, from the user preferences, that are relevant to the vendor;
approve the request for the user preferences when the user device determines that the vendor is authenticated;
retrieve the one or more particular user preferences from the memory based on the approval of the request for the user preferences; and
provide the one or more particular user preferences to the device,
the one or more particular user preferences being used to determine one or more products, services, or content, of the vendor, to offer to the user.

9. The user device of claim 8, where the one or more processors are further to:
disapprove the request for the user preferences when the user device determines that the vendor is not authenticated; and
provide a message to the device indicating that the request for the user preferences is disapproved.

10. The user device of claim 8, where the one or more processors are further to:
receive, from the device, information associated with the one or more products, services, or content to offer to the user, and
provide, for display, the information associated with the one or more products, services, or content to offer to the user.

11. The user device of claim 8, where the one or more processors are further to:
receive an update to the user preferences from the device based on the one or more particular user preferences; and
store the update to the user preferences in the memory.

12. The user device of claim 8, where, prior to receiving the request for the user preferences, the one or more processors are further to:
provide a request for an application to a server device,
the application enabling the user device to:
determine the one or more particular user preferences, and
provide the one or more particular user preferences to the device;
receive the application from the server device based on the request for the application;
initiate a configuration of the application;
provide, based on the configuration, information identifying settings for the application to the server device;
receive configuration information, for the application, from the server device based on the information identifying the settings for the application;
store the configuration information in the memory; and
configure the application based on the configuration information.

13. The device of claim 8, where the request for the user preferences includes:
information identifying the vendor, and
information requesting user preferences relevant to the vendor.

14. The device of claim 8, where the memory stores one or more of:
information associated with public preferences of the user,
information associated with private preferences of the user, or
information associated with trusted vendors.

15. A non-transitory computer-readable medium for storing instructions, the instructions comprising:
one or more instructions that, when executed by one or more processors of a user device, cause the one or more processors to:
receive, from a device, a request for user preferences associated with a user of the user device,
the user preferences being stored in a memory associated with the user device;
authenticate a vendor associated with the device;
determine one or more particular user preferences, from the user preferences, that are relevant to the vendor;
approve the request for the user preferences when the user device determines that the vendor is authenticated;
read the one or more particular user preferences from the memory based on the approval of the request for the user preferences; and
provide the one or more particular user preferences to the device,
the one or more particular user preferences being used to determine one or more products, services, or content, of the vendor, to offer to the user.

16. The computer-readable medium of claim 15, where the instructions further comprise:
one or more instructions that, when executed by the one or more processors, cause the one or more processors to:
disapprove the request for the user preferences when the vendor is not authenticated; and
provide a message to the device indicating that the request for the user preferences is disapproved.

17. The computer-readable medium of claim 15, where the instructions further comprise:
one or more instructions that, when executed by the one or more processors, cause the one or more processors to:
receive, from the device, information associated with the one or more products, services, or content to offer to the user; and
provide, for display, the information associated with the one or more products, services, or content to offer to the user.

18. The computer-readable medium of claim 15, where the instructions further comprise:
one or more instructions that, when executed by the one or more processors, cause the one or more processors to:
receive an update to the user preferences from the device; and
store the update to the user preferences in the memory.

19. The computer-readable medium of claim 15, where the request for the user preferences includes:
information identifying the vendor, and
information requesting user preferences relevant to the vendor.

20. The computer-readable medium of claim 15, where the memory includes one or more of:
information associated with public preferences of the user,
information associated with private preferences of the user, or
information associated with trusted vendors.
